(19) United States
(12) Patent Application Publication
(10) Pub. No.: US 2018/0189814 A1
(43) Pub. Date: Jul. 5, 2018

(54) ELECTRONIC SPELLING GAME AND GAME METHOD

(71) Applicant: XOOKER, LLC, Lexington, KY (US)

(72) Inventors: Conrad R. Carney, II, Lexington, KY (US); John Alan Meister, Lexington, KY (US)

(21) Appl. No.: 15/613,653

(22) Filed: Jun. 5, 2017

Related U.S. Application Data
(60) Provisional application No. 62/440,814, filed on Dec. 30, 2016.

(51) Int. Cl. G06Q 30/02

(52) U.S. Cl. CPC G06Q 30/0209; A63F 13/332; G06Q 30/0222

(57) ABSTRACT

An electronic spelling game includes a control module configured to provide and maintain a letter grid from which players spell words from contiguous letters in order to earn game point awards. A related method of game play is also provided.

This application claims the benefit of U.S. provisional patent application Ser. No. 62/440,814 filed on 30 Dec. 2016, the full disclosure of which is incorporated herein by reference.

### TECHNICAL FIELD

This document relates to a new and improved electronic game in which players attempt to spell words from a random grid of letters with set point values.

### BACKGROUND

Spelling games have long been popular with game players. This document relates to a new and improved electronic spelling game and related game method.

### SUMMARY

In accordance with the purposes and benefits described herein, a new and improved electronic spelling game is provided. That spelling game comprises a control module configured to: (a) provide a plurality of letters in a grid having a first number of columns and a second number of rows, (b) assign a point value for each letter of the plurality of letters, (c) award game points to a player for a word spelled by the player using contiguous letters from the plurality of letters in the grid, (d) delete the contiguous letters from the plurality of letters in the grid; (e) shift letters in a first direction in each column as necessary to fill positions in the grid previously occupied by the contiguous letters; and (f) add new letters from a grid buffer to infill at an end of each column as necessary in order to once again provide a full letter grid.

The control module may also be configured to maintain the grid buffer out of view of the player. The control module may be configured to include a timer and determine a winner of the electronic spelling game based upon the highest game point award total attained by a player within a predetermined time frame.

The control module may be configured to include a timer and determine a winner of the electronic spelling game based upon the highest game point award total attained by a player spelling a predetermined number of words.

The control module may be configured to provide an identical grid and grid buffer to a plurality of different players and determine a winner of the electronic spelling game based upon the highest game point award total earned by any one of the plurality of players within a given elapsed game time.

In accordance with an additional aspect, a method of spelling game play is provided. That method comprises the steps of:

(a) providing, by control module, a plurality of letters in a grid having a first number of columns and a second number of rows;

(b) assigning, by the control module, a point value for each letter of the plurality of letters;

(c) awarding, by the control module, points for a word spelled by a player of the electronic game combining contiguous letters in the grid in any direction;

(d) deleting, by the control module, the contiguous letters from the grid;

(e) shifting, by the control module, letters in a first direction in each column as necessary to fill positions in the grid previously occupied by the contiguous letters; and

(f) adding, by the control module, new letters from a grid buffer to infill at an end of each column as necessary in order to once again provide a full letter grid.

The method may include the step of repeating steps (c)-(f). The method may include the step of maintaining, by the control module, the grid buffer out of view of the player. The method may include the step of determining, by the control module, a winner of the electronic spelling game based upon the highest game point award total attained by a player within a predetermined time frame.

The method may include the step of determining, by the control module, a winner of the electronic spelling game based upon the highest game point award total attained by a player spelling a predetermined number of words.

The method may include the step of providing, by the control module, an identical grid and grid buffer to a plurality of players of the electronic spelling game. The method may include the step of determining, by the control module, a winner of the electronic spelling game based upon the highest game point award total earned by any one of the plurality of players within a given elapsed time.

The method may include the step of downloading the electronic spelling game as an app. The method may include the step of receiving game information from a server over a wireless communication network. The method may include the step of playing the electronic spelling game on a smart phone.

The method may further include the step of incorporating the electronic spelling game into a sales and advertising method. This may include the step of redeeming awarded game points for products and merchandise from a selected supplier or manufacturer. Thus, the method may include promoting businesses of selected suppliers and manufacturers with the electronic spelling game. Further, the method may include determining, by the control module, a winner of the electronic spelling game and rewarding the winner with a discount redeemable for products and merchandise from a selected supplier or manufacturer.

In the following description, there are shown and described several preferred embodiments of the electronic spelling game and related method of play. As it should be realized, the electronic spelling game and related method of play are capable of other, different embodiments and their several details are capable of modification in various, obvious aspects all without departing from the electronic spelling game and related method of play as set forth and described in the following claims. Accordingly, the drawings and descriptions should be regarded as illustrative in nature and not as restrictive.

### BRIEF DESCRIPTION OF THE DRAWING FIGURES

The accompanying drawing figures incorporated herein and forming a part of the specification, illustrate several aspects of the electronic spelling game and related method of play and together with the description serve to explain certain principles thereof.

FIG. 1 is a schematic illustration of a smart phone including a screen displaying the letter grid for playing the electronic spelling game.

FIG. 2 is a view similar to FIG. 1 illustrating the spelling of the word “patent” from contiguous letters of the letter grid.

FIG. 3 is a view similar to FIGS. 1 and 2 but showing the deletion of the contiguous letters used to spell the word “patent” from the letter grid and the infilling of the grid with new letters from the grid buffer.

FIG. 4 is a view similar to FIGS. 1-3 but showing the new full letter grid for the spelling of the next word by a player.

Reference will now be made in detail to the present preferred embodiments of the electronic spelling game and related method of play, examples of which are illustrated in the accompanying drawing figures.

### DETAILED DESCRIPTION

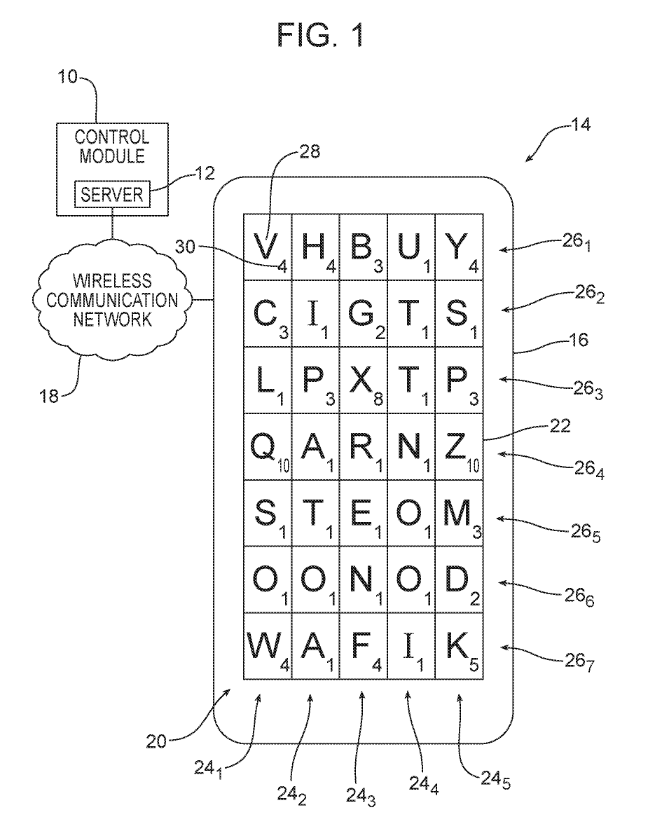

Reference is now made to FIG. 1 illustrating a control module 10 comprising one or more computing devices having one or more processors, one or more memories, and one or more network interfaces all in communication with each other and a server 12 over one or more communication buses. In the illustrated embodiment, the electronic spelling game 14 is stored on the server 12.

The electronic spelling game 14 is played on one or more player devices, such as the illustrated smart phone 16. The player uses his smart phone 16 to communicate with the server 12 over a wireless communication network 18, such as the Internet, in order to download the electronic spelling game 14 as an app. The player is then able to play the electronic spelling game 14 on his smart phone 16.

The electronic spelling game 14 comprises a letter grid 20 displayed on the touchscreen 22 of the smart phone 16. The grid is generated by the control module 10 and sent to the smart phone 16 by the server 12 over the wireless communication network 18. That grid 20 includes a first number of columns 24 and a second number of rows 26. In the illustrated embodiment, there are five columns 21₁-24₅ and seven rows 26₁-26₇. It should be appreciated that the grid 20 may include any reasonable number of columns 24 and rows 26.

As further illustrated in FIG. 1, the grid 20 comprises a plurality of letters 28 in the columns 24 and rows 26. Each letter is assigned a point value 30 by the control module 10. For example, the point value for the letter V is four, the point value for the letter H is four and the point value for the letter B is three. In the illustrated embodiment, the grid 20 includes 35 total letters 28 oriented in five columns 24 and seven rows 26.

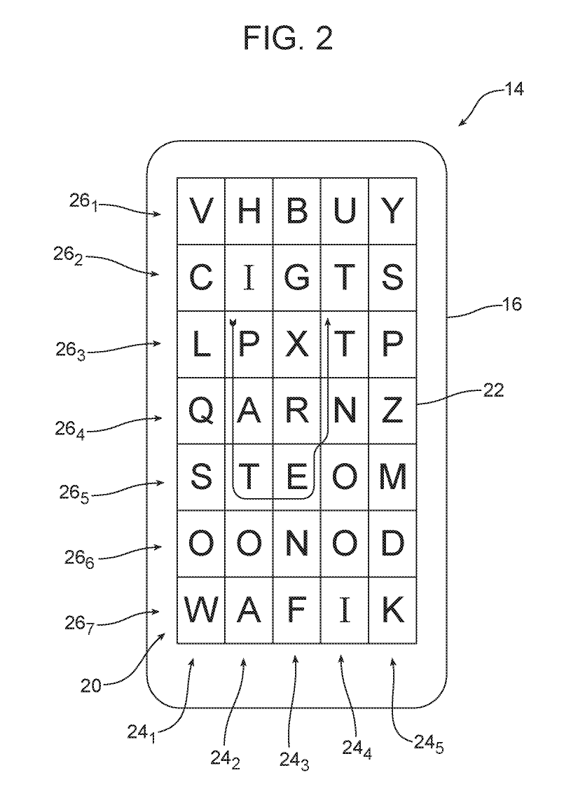

To play the electronic game 14, the player reviews the grid 20 displayed on the display screen 22 of the smart phone 16 and seeks to spell a word with any contiguous letters on the grid. The more letters used to spell the word and the higher the point value assigned to those letters, the more game points are scored. As illustrated in FIG. 2, the player identifies the word “patent” spelled with the letters “PAT” at column 24₂, rows 26₃, 26₄, and 26₅, the letter “E” at column 24₃, row 26₅ and the letters “NT” at column 24₄, rows 26₄ and 26₃. The player selects the contiguous letters to spell the word by running his finger continuously across the touch screen 22 of the smart phone 16 starting at the letter “P”, running down across the letters “AT”, then across to the letter “E”, then diagonally to the letter “N” and finally up to the letter “T”.

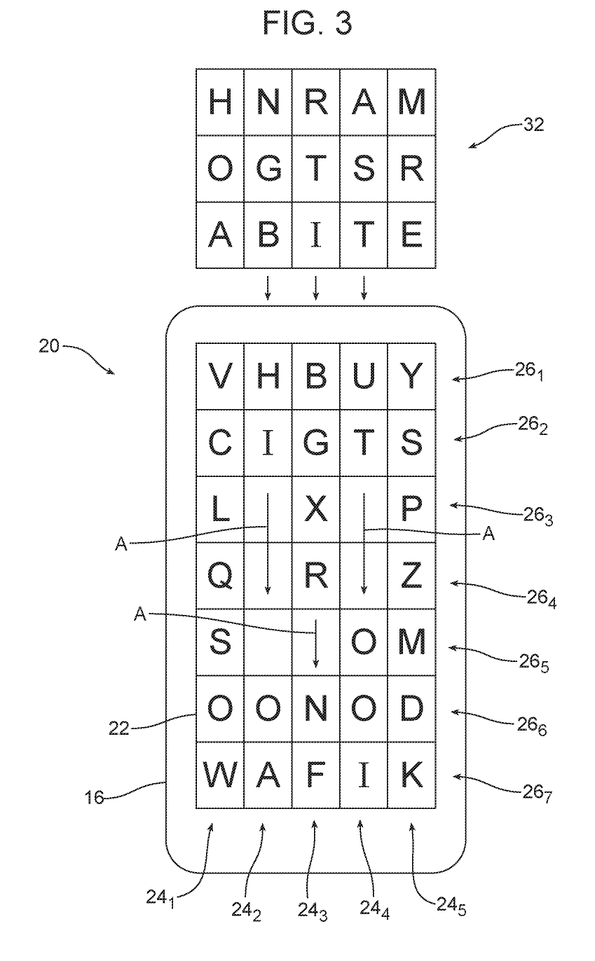

The player then removes his finger from the touch screen 22 indicating that he has completed spelling his word. The smart phone 16 communicates this to the control module 10 over the wireless communication network 18, and the control module then confirms that the spelled word is an acceptable word for the purpose of scoring points. In such an instance, the control module 10 then awards the appropriate game points to the player based upon the point value for the letters used. The game points are communicated to the smart phone 16 through the server 12 by means of the wireless communication network 18 and the control module also deletes the contiguous letters used to spell the word from the grid 20 (See FIG. 3).

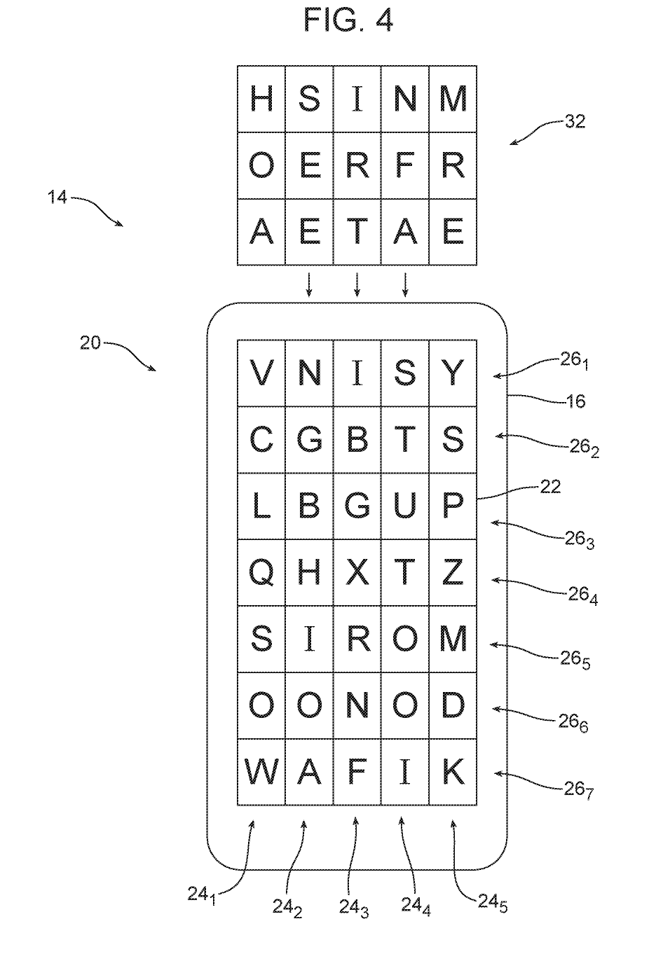

Next, the control module 10 shifts letters 28 in a first direction (note action arrows A in FIG. 3) in each column 24₂, 24₃ and 24₄ as necessary to fill the positions in the grid 20 previously occupied by the now deleted contiguous letters used by the player to spell the word. In addition, new letters are added by the control module 10 at the end of each column 24₂, 24₃ and 24₄ as necessary to once again provide a full letter grid 20. These new letters are added from a grid buffer generally designated by reference letter 32. The grid buffer 32 is illustrated above the smart phone 16 in FIGS. 3 and 4 but it should be appreciated that the grid buffer may be maintained by the control module 10 out of sight and invisible to the player.

Thus, as illustrated in FIGS. 3 and 4, the control module 10 communicates with the smart phone 16 over the wireless communication network 18 so that the existing grid letters “HI” in column 24₂ are moved downward three rows, the existing grid letters “BGXR” in column 24₃ are moved downward one row and the existing grid letters “UT” in column 24₄ are moved downward two rows. Simultaneously, three new letters “NGB” are moved from the second row of the grid buffer 32 into the top three rows 26₁, 26₂, 26₃ of column 24₂, one new letter “I” is moved from the third row of the grid buffer into the top row 26₁ of column 24₃ and two new letters “RE” are moved from the fourth row of the grid buffer into the top two rows 26₁ and 26₂ of the fourth column 24₄. The control module 10 also refills the grid buffer 32 with the next set of letters for each given column.

The steps of play are then repeated with the player again finding and spelling a new word using contiguous letters on the new letter grid 20.

In some embodiments, the control module 10 is configured to include a timer and determine a winner of the electronic spelling game based upon the highest game point award total attained by a player within a predetermined period of time.

In some embodiments, the control module 10 is configured to include a word counter and determine a winner of the electronic spelling game based upon the highest game point award total attained by a player spelling a predetermined number of words.

In still other embodiments, the control module is configured to provide an identical grid and grid buffer to a plurality of different players on different devices/smart phones 16 and determine a winner of the electronic spelling game based upon the highest game point award total earned by any one of the plurality of players within a given elapsed game time. For example, each player may have two minutes to complete their particular game and all players completing a game within a given time period of, for example, 24 hours are compared in order to determine the winner.

As should be appreciated, the electronic spelling game 14 may be incorporated into a sales and advertising method wherein awarded game points are redeemable for products and merchandise from selected suppliers and manufacturers. In this way the electronic spelling game may be used to promote the businesses of suppliers and manufacturers.

Consistent with the above description, a method of electronic spelling game play is provided. That method includes the steps of:
(a) providing, by control module, a plurality of letters in a grid having a first number of columns and a second number of rows;
(b) assigning, by the control module, a point value for each letter of the plurality of letters;
(c) awarding, by the control module, points for a word spelled by a player of the electronic game combining contiguous letters in the grid in any direction;
(d) deleting, by the control module, the contiguous letters from the grid;
(e) shifting, by the control module, letters in a first direction in each column as necessary to fill positions in the grid previously occupied by the contiguous letters; and
(f) adding, by the control module, new letters from a grid buffer to infill at an end of each column as necessary in order to once again provide a full letter grid.

The method may also include repeating steps (c) through (f).

In some embodiments, the method includes maintaining, by the control module, the grid buffer out of view of the player. In some embodiments, the method includes determining, by the control module, a winner of the electronic spelling game based upon the highest game point award total attained by a player within a predetermined time frame. In some embodiments, the method includes the step of determining, by the control module, a winner of the electronic spelling game based upon the highest game point award total attained by a player spelling a predetermined number of words.

In some embodiments, the method includes the step of providing, by the control module, an identical grid and grid buffer to a plurality of players. In such embodiments, the method may further include determining, by the control module, a winner of the electronic spelling game based upon the highest game point award total earned by any one of the plurality of players within a given elapsed time.

Still further, the method may include the step of downloading the electronic spelling game as an app. The method may also include the step of receiving game information from a server over a wireless communication network such as the internet. Further, the method may include the step of playing the electronic spelling game on a smart phone.

In still other embodiments, the method may include the step of incorporating the electronic spelling game into a sales and advertising system or method. In such other embodiments, the method may include the step of redeeming awarded game points for discounts on or even actual products, services and merchandise from a selected supplier or manufacturer. Thus, the method may include promoting businesses of selected suppliers and manufacturers with the electronic spelling game. This could include the step of determining, by the control module, a winner of the electronic spelling game and rewarding the winner with a discount redeemable for products, services and merchandise from a selected supplier or manufacturer.

In still another embodiment, players earn “game points” by playing the word game. The more “game points” the player earns, the more “Xooker Points” the player will be awarded. Players can be awarded 1 to 10 “Xooker Points” per completed game played. “Xooker Points” are accumulated and registered to the player. The player then may go to the Xooker reward catalog and redeem the “Xooker Points” for prizes. Prizes in the Xooker reward catalog list the points needed to redeem that prize.

The foregoing has been presented for purposes of illustration and description. It is not intended to be exhaustive or to limit the embodiments to the precise form disclosed. Obvious modifications and variations are possible in light of the above teachings. All such modifications and variations are within the scope of the appended claims when interpreted in accordance with the breadth to which they are fairly, legally and equitably entitled.

What is claimed:

1. An electronic spelling game, comprising:
a control module configured to (a) provide a plurality of letters in a grid having a first number of columns and a second number of rows, (b) assign a point value for each letter of said plurality of letters, (c) award game points to a player for a word spelled by said player using contiguous letters from said plurality of letters in said grid, (d) delete said contiguous letters from said plurality of letters in said grid; (e) shift letters in a first direction in each column as necessary to fill positions in the grid previously occupied by said contiguous letters; and (f) add new letters from a grid buffer to infill at an end of each column as necessary in order to once again provide a full letter grid.

2. The electronic spelling game of claim 1, wherein said control module is configured to maintain said grid buffer out of view of said player.

3. The electronic spelling game of claim 2, wherein said control module is configured to include a timer and determine a winner of said electronic spelling game based upon the highest game point award total attained by any player within a predetermined time frame.

4. The electronic spelling game of claim 2, wherein said control module is configured to include a word counter and determine a winner of said electronic spelling game based upon the highest game point award total attained by any player spelling a predetermined number of words.

5. The electronic spelling game of claim 2, wherein said control module is configured to provide an identical grid and grid buffer to a plurality of different players and determine a winner of said electronic spelling game based upon the highest game point award total earned by any one of said plurality of players within a given elapsed game time.

6. A method of electronic spelling game play, comprising:
(a) providing, by control module, a plurality of letters in a grid having a first number of columns and a second number of rows;
(b) assigning, by said control module, a point value for each letter of said plurality of letters;
(c) awarding, by said control module, points for a word spelled by a player of said electronic game combining contiguous letters in said grid in any direction;
(d) deleting, by said control module, said contiguous letters from said grid;
(e) shifting, by said control module, letters in a first direction in each column as necessary to fill positions in said grid previously occupied by said contiguous letters; and
(f) adding, by said control module, new letters from a grid buffer to infill at an end of each column as necessary in order to once again provide a full letter grid.

7. The method of claim 6, including repeating steps (c) through (f).

8. The method of claim 6, including maintaining, by said control module, said grid buffer out of view of said player.

9. The method of claim 6, including determining, by said control module, a winner of said electronic spelling game based upon the highest game point award total attained by any player within a predetermined time frame.

10. The method of claim 6, including determining, by said control module, a winner of said electronic spelling game based upon the highest game point award total attained by any player spelling a predetermined number of words.

11. The method of claim 6, including providing, by said control module, an identical grid and grid buffer to a plurality of players.

12. The method of claim 6, including determining, by said control module, a winner of said electronic spelling game based upon the highest game point award total earned by any player within a given elapsed time.

13. The method of claim 6, including downloading said electronic spelling game as an app.

14. The method of claim 13, including receiving game information from a server over a wireless communication network.

15. The method of claim 14, including playing said electronic spelling game on a smart phone.

16. The method of claim 6, including incorporating said electronic spelling game into a sales and advertising method.

17. The method of claim 16, including redeeming awarded game points for discounts on products, services and merchandise from a selected supplier or manufacturer.

18. The method of claim 6, including promoting businesses of selected suppliers and manufacturers with said electronic spelling game.

19. The method of claim 6, including determining, by said control module, a winner of said electronic spelling game and rewarding said winner with a discount redeemable for products, services and merchandise from a selected supplier or manufacturer.
